(19) United States
(12) Patent Application Publication
(10) Pub. No.: US 2019/0168650 A1
(43) Pub. Date: Jun. 6, 2019

(54) FOLDABLE HEAD RESTRAINT

(71) Applicant: WINDSOR MACHINE AND STAMPING (2009) LTD., Windsor (CA)

(72) Inventors: Collins Angelo, Windsor (CA); Mark Little, Windsor (CA)

(21) Appl. No.: 16/206,215

(22) Filed: Nov. 30, 2018

Related U.S. Application Data
(60) Provisional application No. 62/593,520, filed on Dec. 1, 2017.

(51) Int. Cl. B60N 2/856; B60N 2/841

(52) U.S. Cl. CPC B60N 2/856; B60N 2/841

(57) ABSTRACT

A vehicle head restraint assembly includes a base portion coupleable to a vehicle seat back, the base portion including a cross member portion. Also included is a head restraint operatively coupled to the cross member portion and rotatable about the cross member portion. Further included is a locking mechanism. The locking mechanism includes a lock surrounding the cross member portion and fixed in a non-rotatable manner thereto. The locking mechanism also includes a lock slide having at least one lock tooth engageable with the lock, the lock tooth moveable relative to the lock between a locked condition and an unlocked condition.

### CROSS-REFERENCE TO RELATED APPLICATION

This application claims priority to U.S. Provisional Patent Application No. 62/593,520, filed on Dec. 1, 2017, the disclosure of which is incorporated herein by reference in its entirety.

### BACKGROUND

The subject matter disclosed herein relates to head restraints and, more particularly, to a foldable head restraint.

Many vehicles, such as automobiles, include a headrest or head restraint atop an occupant's seat and in a position adjacent the occupant's head. Head restraints are typically cushioned for comfort, are height adjustable, and most are commonly finished in the same material as the rest of the seat. Some head restraints are adjustable in one or more manners. Mechanisms that facilitate such adjustment must meet packaging and operating constraints, which is often challenging.

### BRIEF DESCRIPTION

According to one aspect of the disclosure, a vehicle head restraint assembly includes a base portion coupleable to a vehicle seat back, the base portion including a cross member portion. Also included is a head restraint operatively coupled to the cross member portion and rotatable about the cross member portion. Further included is a locking mechanism. The locking mechanism includes a lock surrounding the cross member portion and fixed in a non-rotatable thereto. The locking mechanism also includes a lock slide having at least one lock tooth engageable with the lock, the lock tooth moveable relative to the lock between a locked condition and an unlocked condition.

According to another aspect of the disclosure, a vehicle head restraint assembly includes a base portion coupleable to a vehicle seat back, the base portion including a cross member portion. The assembly also includes a head restraint operatively coupled to the cross member portion and rotatable about the cross member portion. The assembly further includes a locking mechanism. The locking mechanism includes a lock surrounding the cross member portion and fixed in a non-rotatable manner thereto, the lock including a first protrusion and a second protrusion spaced from each other to define a lock tooth path therebetween. The lock mechanism also includes a lock slide having a tooth moveable relative to the lock between a locked condition and an unlocked condition, the locked condition defined by misalignment of the lock tooth and the lock tooth path, the unlocked condition defined by alignment of the lock tooth and the lock tooth path.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a front, elevational view of a head restraint assembly;

FIG. 2 is a rear, elevational view of the head restraint assembly;

FIG. 3 is a partially disassembled view of the head restraint assembly;

FIG. 4 is a perspective view of a frame member of the head restraint assembly;

FIG. 5 is a perspective view of a push button of the head restraint assembly;

FIG. 6 is a perspective view of the head restraint assembly in an upright position;

FIG. 7 is a perspective view of the head restraint assembly in a folded position;

FIG. 8 is a perspective view of a locking mechanism within the head restraint assembly in an upright, locked condition;

FIG. 9 is a rear, perspective view of the locking mechanism in the upright, locked condition;

FIG. 10 is a front, perspective view of the locking mechanism in the upright, locked condition;

FIG. 11 is a cross-sectional view of the locking mechanism illustrating positioning of lock teeth in the upright, locked condition;

FIG. 12 is a perspective view of the locking mechanism within the head restraint assembly in an upright, unlocked condition;

FIG. 13 is a rear, perspective view of the locking mechanism in the upright, unlocked condition;

FIG. 14 is a front, perspective view of the locking mechanism in the upright, unlocked condition;

FIG. 15 is a cross-sectional view of the locking mechanism illustrating positioning of lock teeth in the upright, unlocked condition;

FIG. 16 is a perspective view of the locking mechanism within the head restraint assembly in a folded position;

FIG. 17 is a perspective view of the locking mechanism in the folded position;

FIG. 18 is a perspective view of the locking mechanism in the folded position according to another aspect of the invention;

FIG. 19 is a partially disassembled view of a base assembly and lock of the head restraint assembly;

FIG. 20 is a perspective view of the base assembly and the lock in an assembled condition;

FIG. 21 is a perspective view of the head restraint assembly with a cam, the head restraint assembly in the upright, locked condition;

FIG. 22 is a perspective view of the head restraint assembly with the cam, the head restraint assembly in the upright, unlocked condition;

FIG. 23 is a perspective view of the head restraint assembly with the cam, the head restraint assembly in the folded position;

FIG. 24 is a perspective view of the head restraint assembly with a cable connected to the cam;

FIG. 25 is a perspective view illustrating a partially disassembled view of the base assembly and the lock of the head restraint assembly according to another aspect of the disclosure; and

FIG. 26 is a cross-sectional view of the locking mechanism illustrating positioning of lock teeth in the upright, locked condition according to another aspect of the disclosure.

The detailed description explains embodiments of the invention, together with advantages and features, by way of example with reference to the drawings.

### DETAILED DESCRIPTION

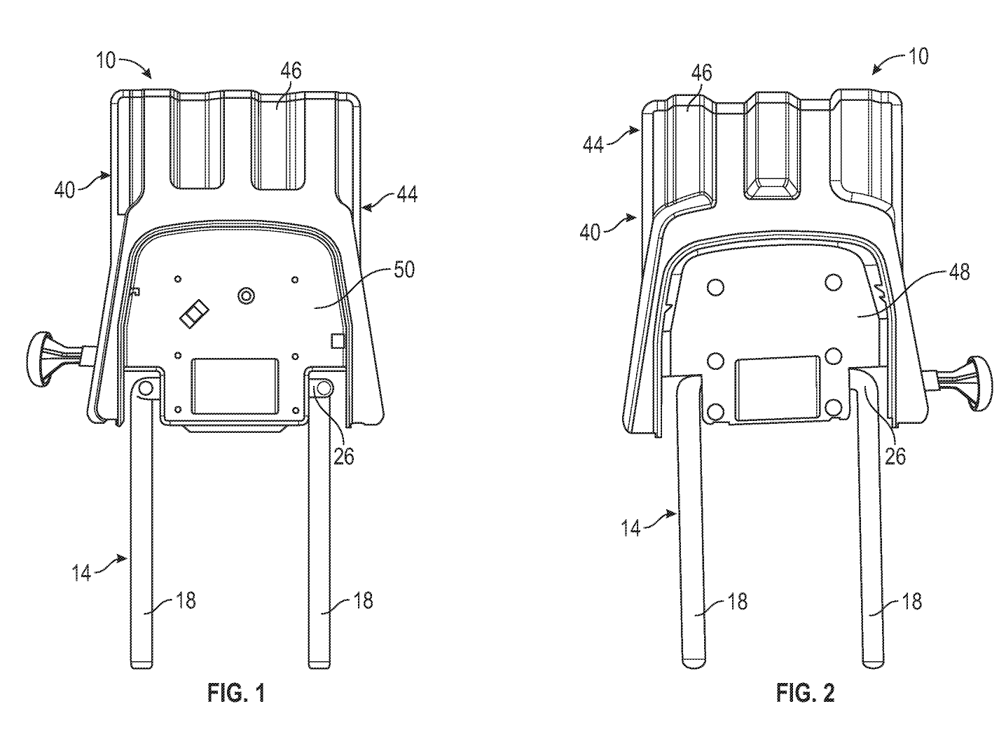

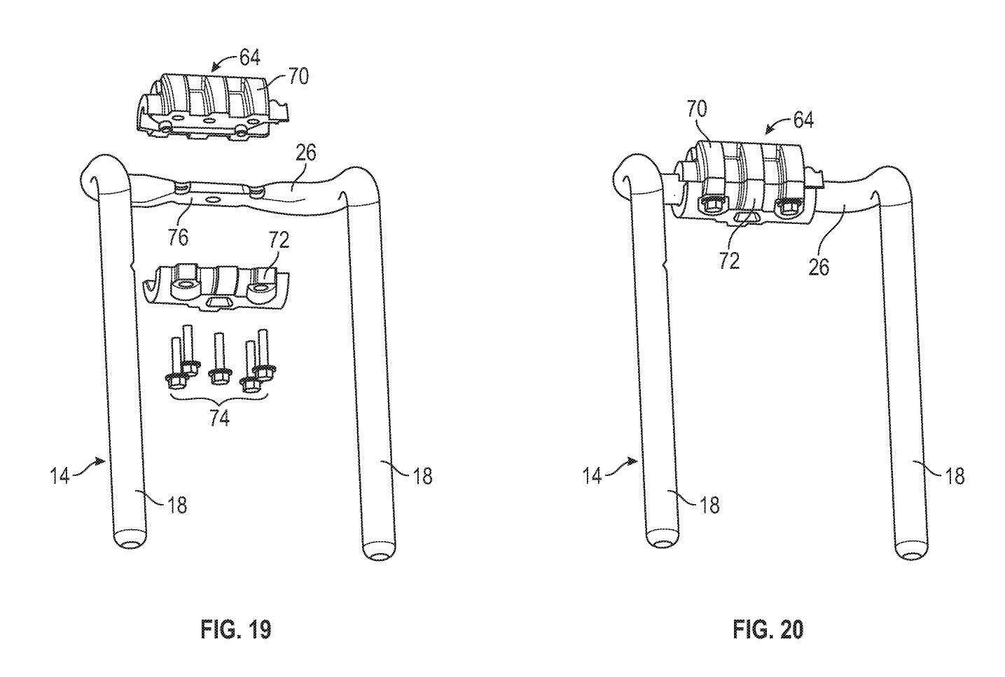

Referring to FIGS. 1 and 2, a head restraint assembly 10 is depicted. The head restraint assembly 10 is illustrated without a cover to show components partially or completely disposed therein. The head restraint assembly 10 includes a base portion 14 (which may also be referred to as an “armature”) that is mountable to a vehicle seat (not shown), and, more specifically, to the upper portion of the seatback of the vehicle seat. In the illustrated embodiment, the base portion 14 is formed from a single piece of metal and includes two parallel post portions 18 that are mounted, or mountable, to the top of the seatback of the vehicle seat, as understood by those skilled in the art. Each of the post portions 18 includes a respective elongated, straight portion. Each of the straight portions extends into a respective hole formed in the top of the seatback to attach the head restraint assembly 10 to the vehicle seat. The base portion 14 is also illustrated in detail in FIGS. 19 and 20.

As shown, the base portion 14 also includes a cross member portion 26 that interconnects the two post portions 18. The cross member portion 26 extends substantially transversely relative to the post portions 18. For example, when the base portion 14 is connected to a vehicle seat, the post portions 18 are generally vertical, and the cross member portion 26 is generally horizontal.

The head restraint assembly 10 further includes a head restraint 40 operatively connected to the base portion 14. In the embodiment depicted, the head restraint 40 includes a frame structure 44 that provides rigid structure to the head restraint 40. A head restraint cushion (not shown) is comprised of soft foam or a like material to provide a cushion between the head of a human occupant of the vehicle seat and the head restraint frame structure 44. The head restraint cover covers at least part of the cushion and the housing to enhance the aesthetics of the head restraint. Exemplary cover materials include cloth, vinyl, leather, etc.

The frame structure 44 includes one or more components, such as the illustrated first frame member 46, second frame member 48, and shell 50. The frame structure 44 may be formed of numerous contemplated materials. In one embodiment, the frame structure 44 is formed of plastic. Two apertures are defined by the cover and/or at least one other internal component, with each aperture configured to receive one of the posts 18. The posts 18 of the base portion extend through a respective one of the apertures to enter an internal cavity of the head restraint 40. The cross member portion 26 extends through the internal cavity.

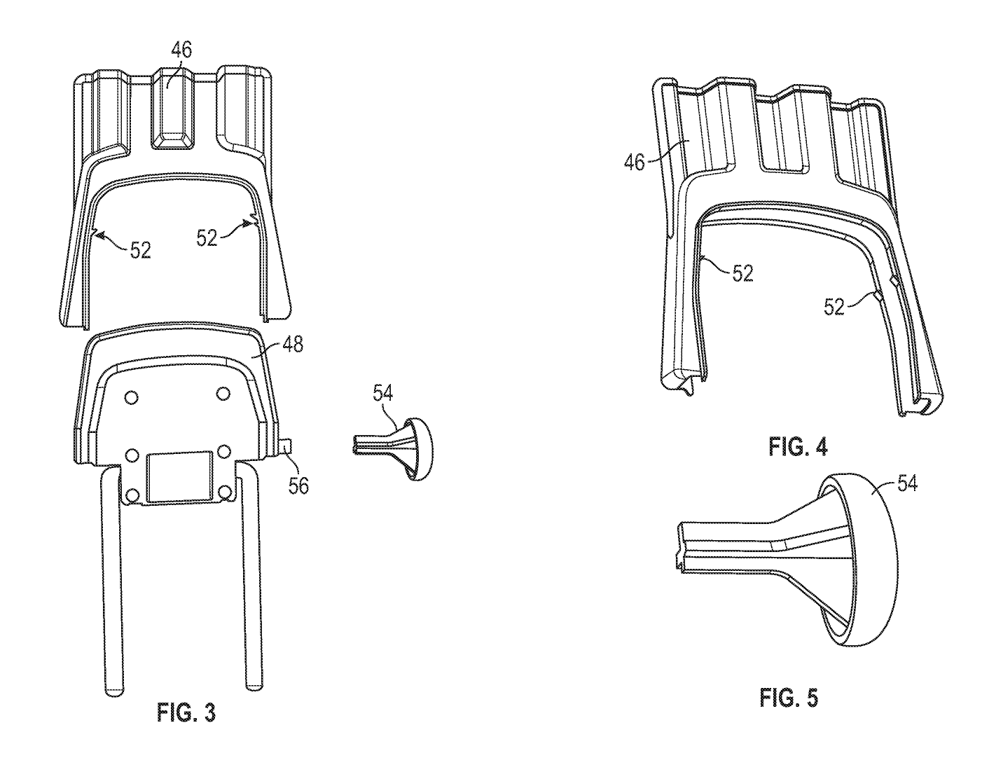

Referring now to FIG. 3, the head restraint assembly 10 is shown in a partially disassembled condition. In particular, the first frame member 46 is separated from the second frame member 48 and the shell 50. The first frame member 46 may be operatively coupled to the second frame member 48 and/or the shell 50 in multiple contemplated manners. In the illustrated embodiment, the frame members are coupled in a snap-fitting manner. For example, in the illustrated embodiment of FIGS. 3 and 4, the first frame member 46 includes protrusions 52 that are received within receiving features of the second frame member 48. It is to be appreciated that the second frame member 48 may have the protrusions, with the first frame member 46 having receiving features. Although a snap-fit assembly is described above and illustrated, it is to be understood that alternative coupling methods may be employed, such as the use of mechanical fasteners, for example.

A push button 54 (FIG. 5) is also shown removed from the frame structure 44 in FIG. 3. The push button 54 may be coupled to the frame structure 44 in several different manners. In the illustrated embodiment, the push button 54 is press fit into a push button housing 56 that is coupled to, or integrally formed with, the frame structure 44. The push button 54 protrudes from the cover of the head restraint 40 to be accessible to a user at an exterior of the head restraint 40. As described herein, the push button 54 allows a user to manually unlock the head restraint 40 in preparation for rotation of the head restraint 40 from an upright position to a folded position.

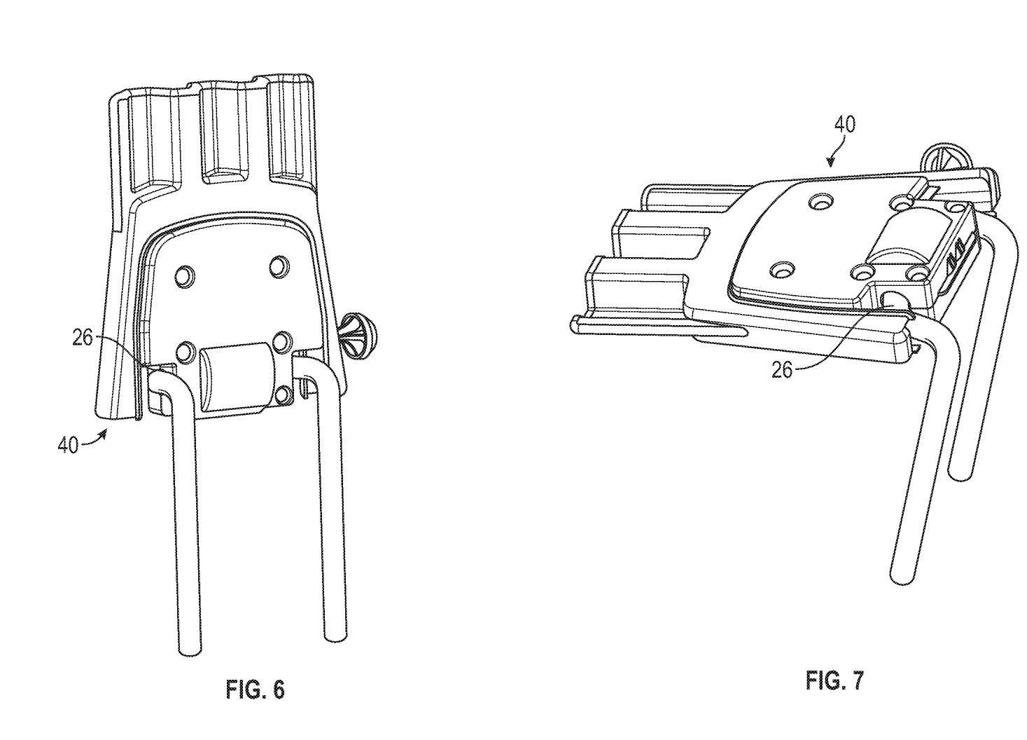

Referring now to FIGS. 6 and 7, the head restraint 40 is pivotable (also referred to herein as foldable) about the cross member portion 26 between a substantially upright position (FIG. 6) and a downwardly rotated position (FIG. 7). The upright position is defined by a range of angular positions that are closer to a vertical orientation of the head restraint 40 than a horizontal orientation of the head restraint 40, with the top of the head restraint 40 disposed above the bottom of the head restraint 40. The downward position is defined by a range of angular positions that are closer to the horizontal orientation of the head restraint 40 than the vertical orientation of the head restraint 40. Such embodiments include the head restraint 40 being rotatable about 90 degrees from a substantially vertical position to a substantially horizontal position. In alternative embodiments, the head restraint 40 is pivotable about more than 90 degrees, such as 180 degrees to position the top of the head restraint 40 below the bottom of the head restraint 40 in a substantially vertical orientation.

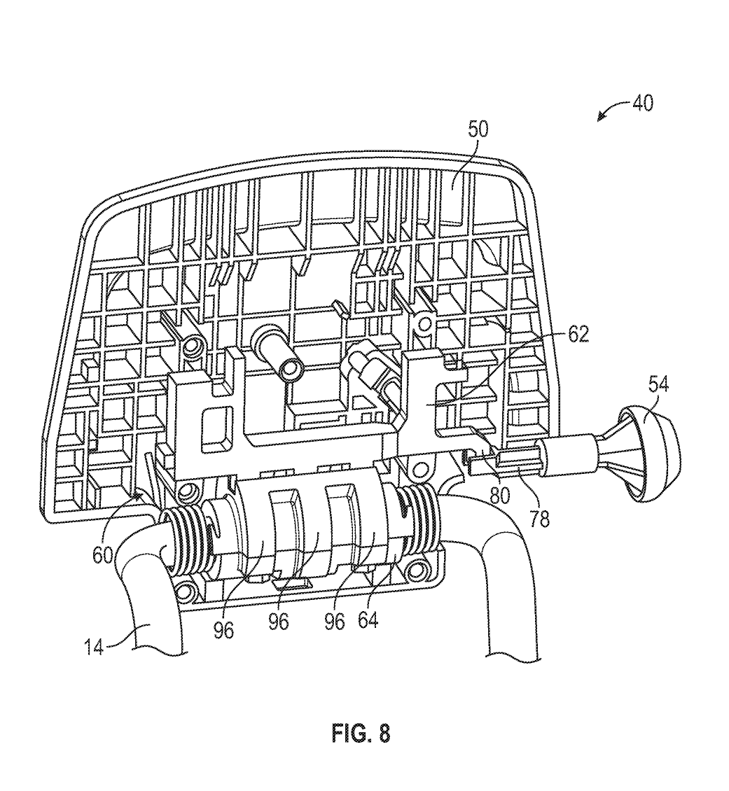

Referring to FIG. 8, frame members 46, 48 are removed to better illustrate a locking mechanism 60 that locks the head restraint 40 with respect to the base portion 14, thereby preventing rotation of the head restraint 40 relative to the base portion 14, but is selectively unlocked to allow rotation of the head restraint 40, relative to the base portion 14. For example, the locking mechanism 60 locks the head restraint 40 in the upright position and may be selectively operated to allow the head restraint 40 to rotate forwardly. The locking mechanism 60 includes a lock slide 62 and a lock 64.

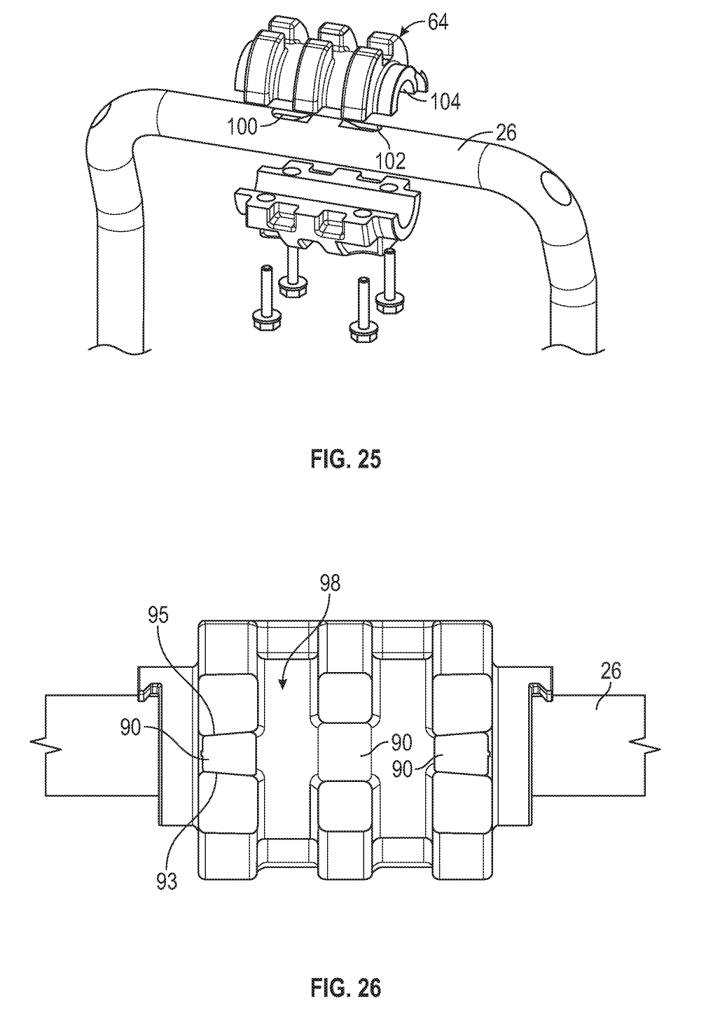

As shown in FIGS. 19 and 20, the lock 64 is fixedly coupled to the cross member portion 26 of the base portion 14. In the illustrated embodiment, the lock 64 is a two-piece assembly that is split in half into a first lock part 70 and a second lock part 72, but it is to be appreciated that different constructions may be utilized. The first and second lock parts 70, 72 surround a portion of the cross member portion 26 and are coupled to each other to retain the lock parts together and to secure them to the cross member portion 26. The lock parts 70, 72 may be coupled with mechanical fasteners 74, as shown. The portion of the cross member portion 26 to which the lock 64 is secured to includes a shape or feature(s) that do not permit rotation of the lock 64 relative to the base portion 14. In the illustrated embodiment, the cross member portion 26 includes a flattened portion 76 that is non-cylindrical to provide the non-rotational coupling of the lock 64 to the base portion 14. Alternative geometries are contemplated, with the lock 64 having complementary features and/or geometry to ensure non-rotation, as shown in FIG. 25. FIG. 25 includes a substantially cylindrical cross member portion 26, but recesses 100, 102 are provided as key features that mate with protrusions extending from an inner surface 104 of the lock 64. Any number of key features may be provided and in numerous contemplated geometries.

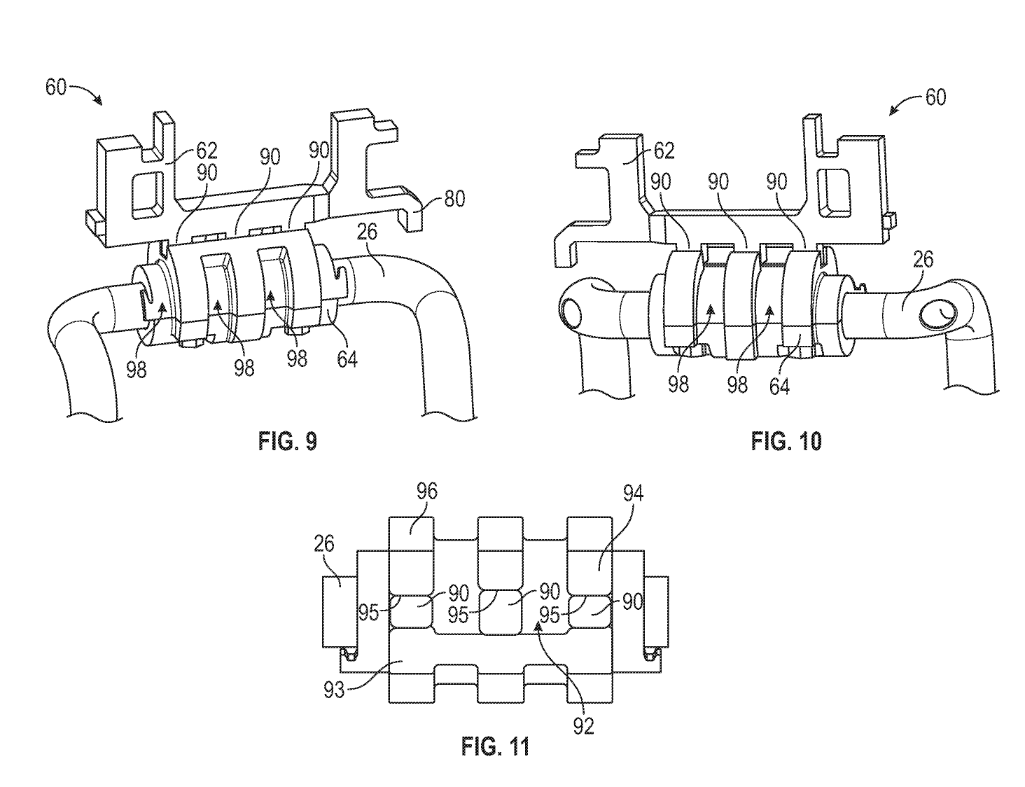

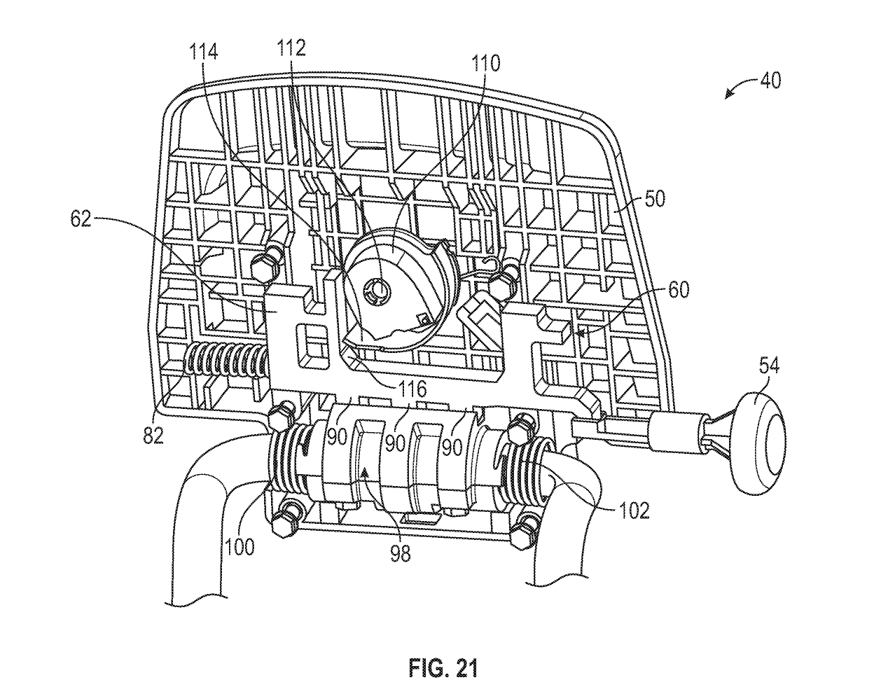

FIGS. 8-11 illustrate the head restraint 40 in an upright and locked condition. The lock slide 62 is in direct or indirect contact with the push button 54, or an extension of the push button 54. In the illustrated example, an arm 78 of the push button housing 56 receives a tab 80 of the lock slide 62 to facilitate coordinated movement of the push button 54 and the lock slide 62. A biasing member 82, such as a coil spring or the like, is engaged with the lock slide 62 to bias the lock slide 62 toward an extended position of the push button 54, as shown in FIGS. 21-24. Manual depression of the push button 54 must overcome the biasing force of the biasing member 82 to translate the lock slide 62 out of the locked condition shown in FIGS. 8-11.

In the locked condition, one or more lock teeth 90 extending from the lock slide 62 are disposed within a groove 92 that extends along a longitudinal direction of the cross member portion 26. In the illustrated embodiment, three lock teeth 90 are included, but it is to be appreciated that more or fewer lock teeth may be present. The groove 92 is defined by a continuous wall 93 that extends continuously in the longitudinal direction of the groove 92 and by a discontinuous wall 94. The discontinuous wall 94 is formed with ends 95 of protrusions 96. The protrusions 96 extend circumferentially around the lock 62 and define annular lock teeth paths 98. In the locked position, the lock teeth 90 are aligned with the ends 95 of the protrusions 96 to sandwich the lock teeth 90 between the continuous wall 93 and the discontinuous wall 94. To facilitate a meshed engagement of the lock teeth 90 with the walls 93, 94, one or more of the lock teeth 90 may be tapered. As shown in the embodiment of FIG. 11, only the outer lock teeth 90 are tapered in some embodiments, but it is to be appreciated that all or none of the lock teeth 90 are tapered in some embodiments. The extent to which the lock teeth 90 are tapered may differ depending upon the application. In one example, the lock teeth 90 are tapered about 4 degrees. As shown in FIG. 26, some embodiments of wall 93 include a discontinuous wall 106.

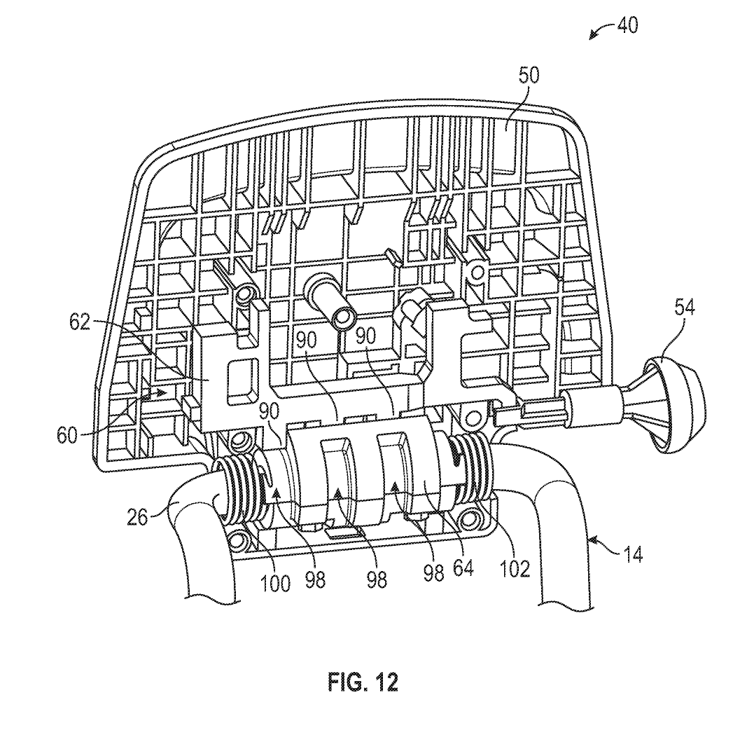

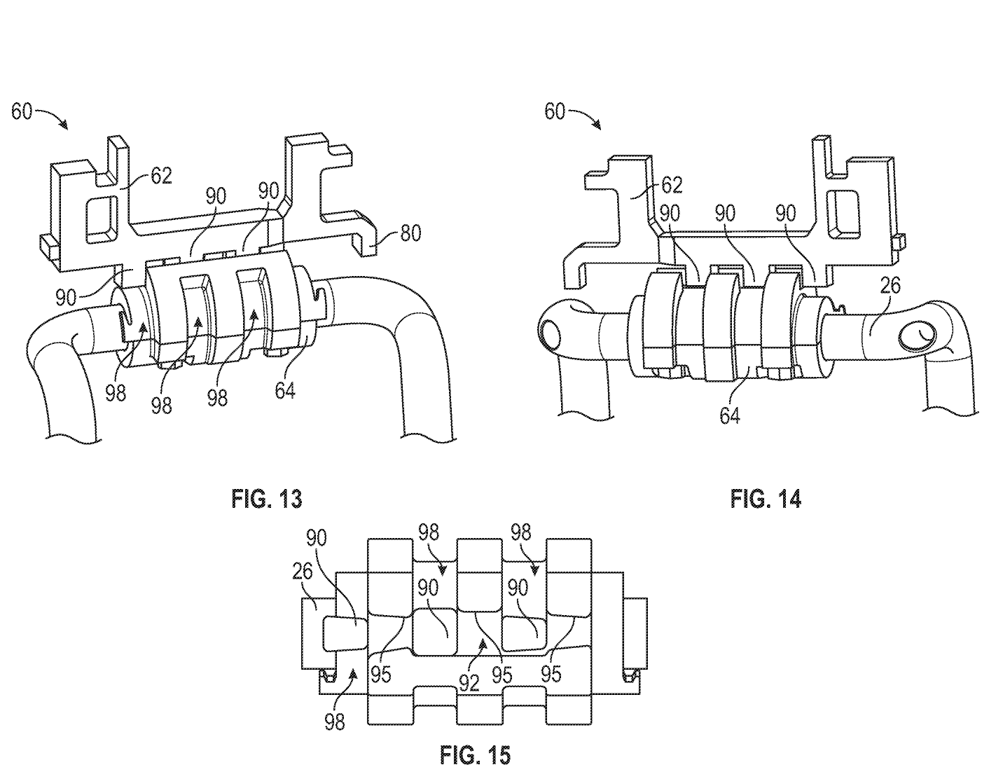

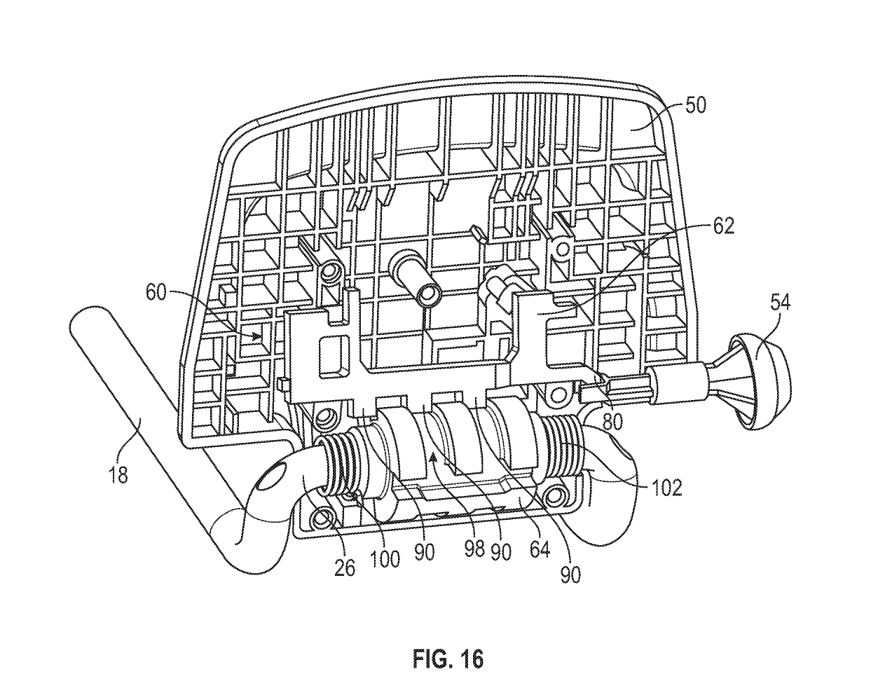

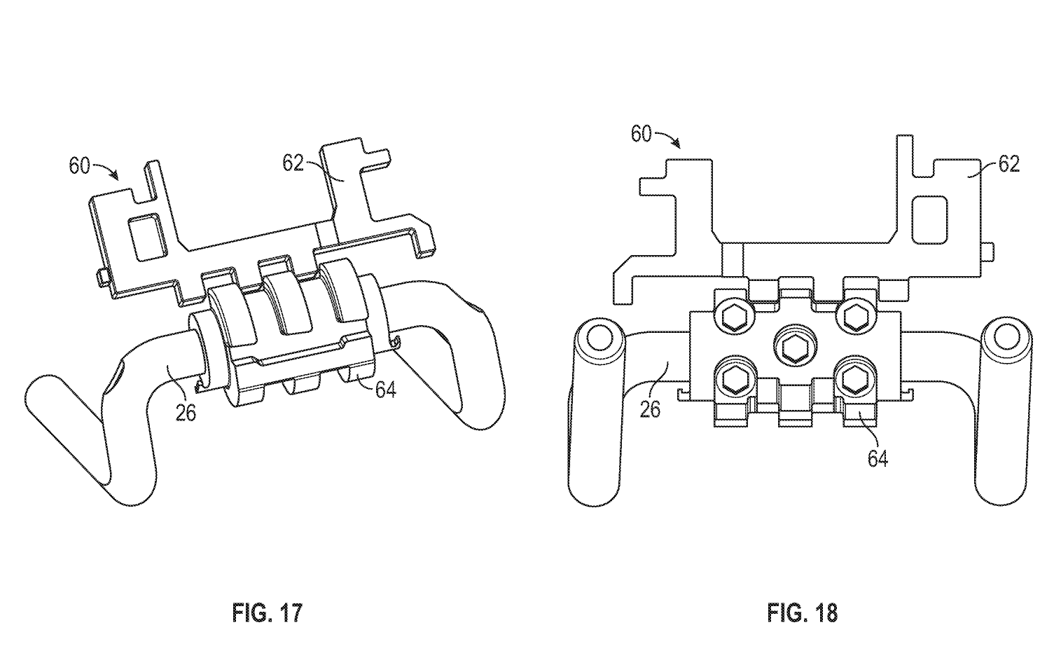

Referring now to FIGS. 12-15, the locking mechanism 60 is shown in a disengaged condition with the head restraint 40 in the upright position. In this position, the push button 54 has been depressed to translate the lock slide 62 to an extent necessary to misalign the lock teeth 90, relative to the ends 95 of the discontinuous wall 94. The lock teeth 90 are then axially aligned with the annular lock teeth paths 98, thereby allowing the lock slide 62 to rotate relative to the lock 64, and hence the base portion 14. Such movement imparts rotation of the head restraint 40 to which the lock slide 62 is operatively coupled to. Rotation moves the head restraint 40 to a folded position. In the illustrated embodiment, rotation is urged with two springs 100, 102, but in some embodiments a single spring is employed or more than two springs are included. Therefore, with springs 100, 102, once the lock teeth 90 are aligned with the annular lock teeth paths 98 the lock slide 62 is automatically rotated to the folded position, as shown in FIGS. 16-18. A stop surface is provided to cease rotation of the head restraint 40 at a desired position. For example, as discussed above, the stop surface may be positioned to halt movement of the head restraint 40 after a 90 degree rotation. The stop surface may be integrated with the lock 64 or some other component of the head restraint 40.

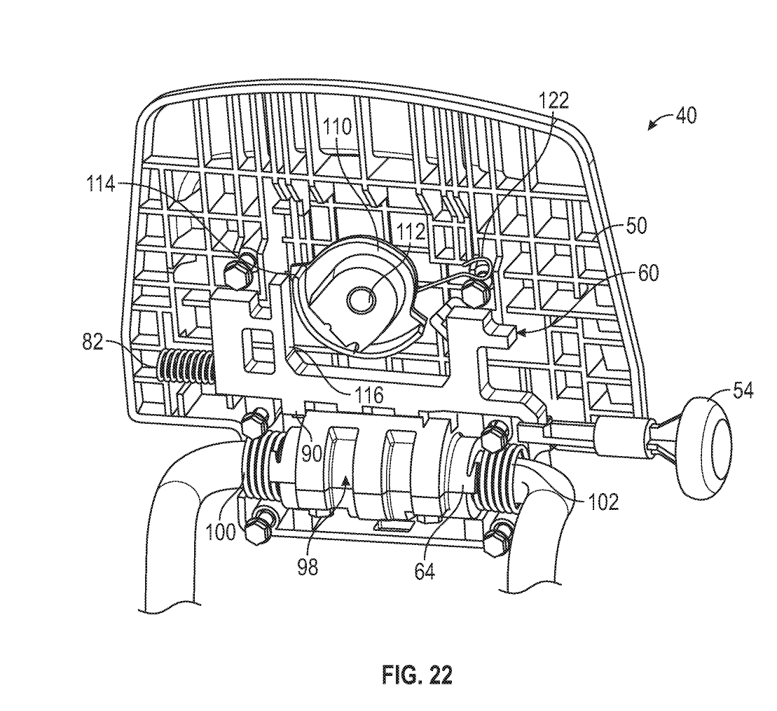

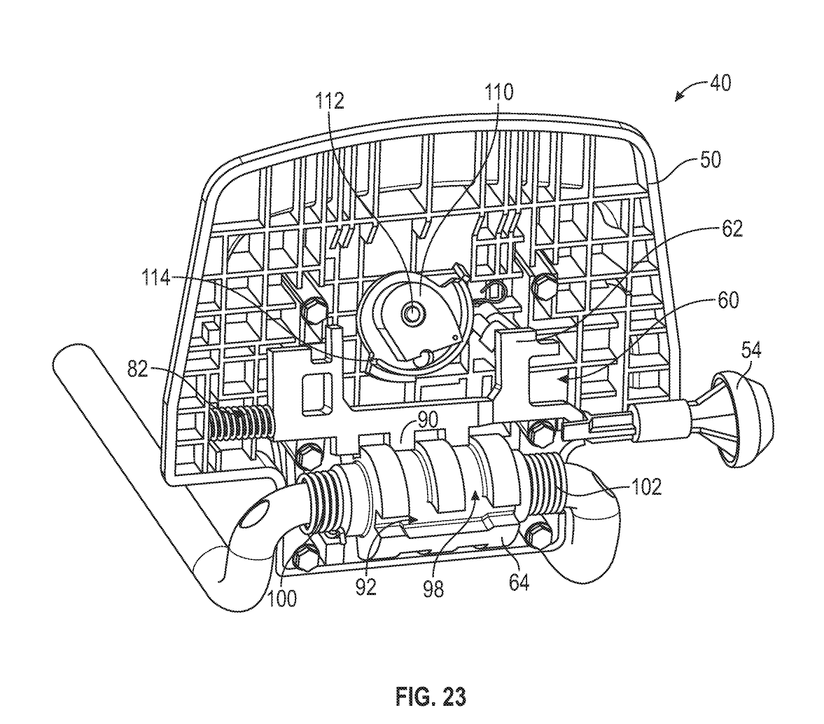

Referring now to FIGS. 21-24, another aspect of the locking mechanism 60 is illustrated. As described above, folding of the head restraint 40 may be actuated manually by depressing the push button 54, which initiates translation of the lock slide 62 to align the lock teeth 90 with the annular lock teeth paths 98. Alternatively, a cam 110 may be operatively coupled to the shell 50 in a position that allows the cam 110 to interact with the lock slide 62. The cam 110 in the illustrated embodiment is a rotatable cam that is secured to a pin 112 of the shell 50 that the cam 110 is rotatable about. The cam 110 includes a surface 114 that is disposed in contact with, or in close proximity to, an engagement surface 116 of the lock slide 62 when the locking mechanism 60 is in the locked condition (FIG. 21). Rotation of the cam 110 exerts a force on the lock slide 62 that is sufficient to overcome the biasing force of the biasing member 82, thereby translating the lock slide 62. As described above, translation of the lock slide 62 moves the lock teeth 90 into alignment with the annular lock teeth paths 98 to unlock the head restraint 40 (FIG. 22). In this position, as with actuation with the push button 54, the spring(s) 100, 102 bias the head restraint 40 to the folded position (FIG. 23).

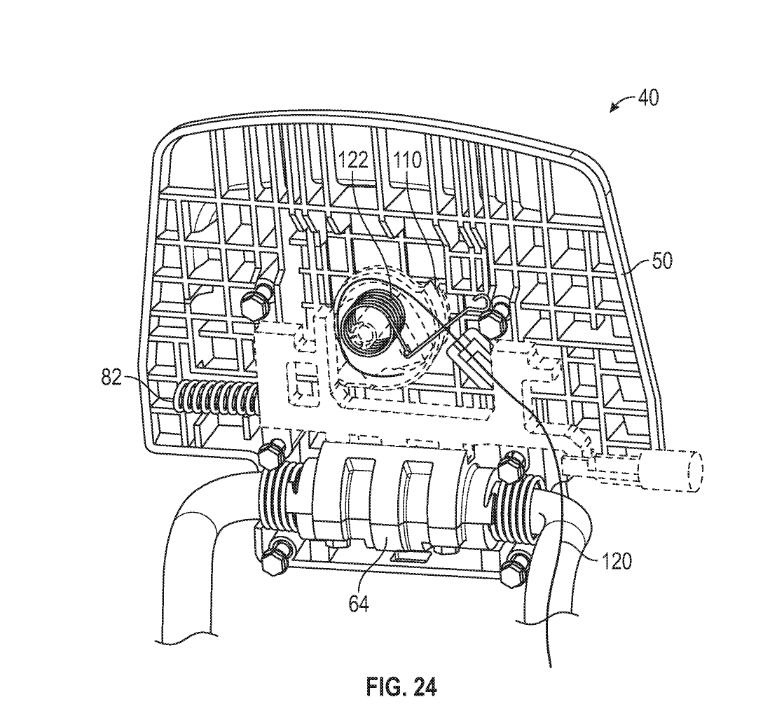

Actuation of the cam 110 may be initiated in different manners in various embodiments. As shown in FIG. 24, a cable 120 may be routed through the head restraint assembly 10 to be connected to the cam 110. In the illustrated embodiment, the cable 120 is routed through the post 18, but this is merely an example. The cable 120 may be placed into sufficient tension to rotate the cam 110 with a strap or other structural feature that a user may manipulate. Alternatively, an electric actuator may be in contact with the cable 120 or directly with the cam 110. Additionally, a cam arrangement may respond to motion of the vehicle seat to which the head restraint 40 is attached to actuate the cam 110 to automatically rotate the head restraint 40 to the folded position in response to certain motion of the seat, such as stowing of the seatback, for example. The cam 110 includes a return spring 122 that returns the cam 110 to a default position.

It is to be appreciated that some embodiments of the locking mechanism 60 include only the push button actuation capability. In other embodiments, the locking mechanism includes only the cam actuation capability. In yet further embodiments, both the push button and the cam are present and may be selectively used.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A vehicle head restraint assembly comprising:
a base portion coupleable to a vehicle seat back, the base portion including a cross member portion;
a head restraint operatively coupled to the cross member portion and rotatable about the cross member portion; and
a locking mechanism comprising:
a lock surrounding the cross member portion and fixed in a non-rotatable manner thereto; and
a lock slide having at least one lock tooth engageable with the lock, the lock tooth moveable relative to the lock between a locked condition and an unlocked condition.

2. The assembly of claim 1, wherein the lock slide is actuated with a push button assembly accessible to a user.

3. The assembly of claim 2, wherein the push button assembly includes an arm in contact with a portion of the lock slide to actuate movement of the lock slide during depression of the push button assembly.

4. The assembly of claim 1, wherein the lock is a multi-piece assembly comprising a first lock part and a second lock part surrounding a portion of the cross member portion and coupled to each other.

5. The assembly of claim 1, wherein the cross member portion further includes at least one geometrical feature that does not permit rotation of the lock relative to the base portion of the head restraint.

6. The assembly of claim 5, wherein the at least one geometrical feature is a flattened portion of the cross member.

7. The assembly of claim 5, wherein the at least one geometrical feature is at least one recess defined by the cross member portion which is engageable with at least one protrusion extending from an inner surface of the lock.

8. The assembly of claim 1, wherein a biasing member is located on a side of the lock slide that is opposite the push button assembly, the biasing member biasing the lock slide toward an extended position of the push button assembly.

9. The assembly of claim 1, wherein the lock contains a groove defined by a continuous wall that extends in the longitudinal direction of the groove and by a discontinuous wall formed by ends of a plurality of protrusions.

10. The assembly of claim 9, wherein at least one tooth of the lock slide is one of a plurality of lock teeth, the lock teeth moveable within the groove of the lock.

11. The assembly of claim 10, wherein at least one of the lock teeth are tapered.

12. The assembly of claim 11, wherein the at least one tapered lock tooth has a taper angled of about 4 degrees.

13. The assembly of claim 1, wherein the lock includes a stop surface is provided to set a rotatable stop location of the head restraint.

14. The assembly of claim 13, wherein the rotatable stop location is about 90 degrees from an upright position of the head restraint.

16. The assembly of claim 1, wherein the lock slide is actuated with a cam disposed within an interior of the head restraint, the cam having a cam surface in contact with an engagement surface of the lock slide.

17. The assembly of claim 16, wherein the cam is a rotatable cam that is rotatable about a pin of the shell.

18. The assembly of claim 17, further comprising:
a cable in operative contact with the cam to actuate rotation of the cam; and
a return spring that returns the cam to a default position.

19. The assembly of claim 18, wherein an electric actuator automatically rotates the cam in response to a motion of the seat.

20. A vehicle head restraint assembly comprising:
a base portion coupleable to a vehicle seat back, the base portion including a cross member portion;
a head restraint operatively coupled to the cross member portion and rotatable about the cross member portion; and
a locking mechanism comprising:
a lock surrounding the cross member portion and fixed in a non-rotatable manner thereto, the lock including a first protrusion and a second protrusion spaced from each other to define a lock tooth path therebetween; and
a lock slide having a tooth moveable relative to the lock between a locked condition and an unlocked condition, the locked condition defined by misalignment of the lock tooth and the lock tooth path, the unlocked condition defined by alignment of the lock tooth and the lock tooth path.
